(19) United States
(12) Patent Application Publication
(10) Pub. No.: US 2008/0183379 A1
(43) Pub. Date: Jul. 31, 2008

(54) REGISTRATION INFORMATION DISPLAY PROCESSING METHOD AND DEVICE AND PROGRAM THEREFOR

(75) Inventor: Kenji ITO, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/013,801

(22) Filed: Jan. 14, 2008

(30) Foreign Application Priority Data
Jan. 29, 2007 (JP) JP2007-017267

(51) Int. Cl. G01C 21/34

(52) U.S. Cl. 701/206

(57) ABSTRACT

In a registration information display processing system, when a map obtaining request containing a display range is received from a user terminal, a registration information data base storing registration information registered in association with a specific position on a map is referred to, and registration information whose registration position is contained in an indicated display range is extracted. A plan data base storing identification information of a plan affecting map elements and a plan range of the plan is referred to and it is judged whether the registration position of the registration information is contained in the plan range of the plan. When judged the registration position of the registration information is contained in the plan range of the plan, identification information of the plan is stored in association with registration information. Map data are generated emphasis-displaying an icon corresponding to registration information associated with identification information of the plan.

### CROSS-REFERENCE TO RELATED APPLICATIONS

This application is related to and claims priority to Japanese patent application no. 2007-17267 filed on Jan. 29^{th}, 2007 in the Japan Patent Office, and incorporated by reference herein.

### BACKGROUND

1. Field

The embodiments relate to an information processing technique for displaying, on a map, registration information (for example, information associated with shops, etc.) registered in connection with the map.

### SUMMARY

According to an aspect of an embodiment, a registration information display processing method executed by a computer comprises referring to a registration information data base for storing registration information registered in association with a specific position on a map as a registration position of the registration information, when a map obtaining request containing an indication of a display range is received from a user terminal, extracting registration information whose registration position is contained in an indicated display range and storing the registration information concerned into a storage device; an in-plan-range judging by referring to a plan data base for storing identification information of a plan affecting map elements and a plan range of the plan concerned, and judging whether the registration position of the registration information stored in the storage device is contained in the plan range of the plan stored in the plan data base; plan associating by storing into the storage device identification information of a plan stored in the plan data base in association with registration information stored in the storage device when it is judged that the registration position of the registration information concerned is contained in the plan range of the plan concerned; and map data generating by generating map data so as to emphasis-display an icon corresponding to registration information associated with identification information of a plan out of icons which correspond to registration information stored in the storage device and are displayed on the map, and transmitting the map data to the user terminal.

### BRIEF DESCRIPTION OF THE DRAWINGS

FIG. 1 is a diagram showing a conventional map search service;

FIG. 2 is a diagram showing a conventional map search service;

FIG. 3 is a schematic diagram showing a system according to an embodiment;

FIG. 4 is a diagram showing an example of a blog registration information table;

FIG. 5 is a diagram showing an example of a display range table;

FIG. 6 is a diagram showing an example of a plan table;

FIG. 7 is a diagram showing a processing flow when blog registration information is registered;

FIG. 8 is a diagram showing a processing flow when blog registration information is searched;

FIG. 9 is a diagram showing a processing flow of processing of specifying blog information being noted;

FIG. 10 is a diagram showing an example of data stored in a work memory;

FIG. 11 is a diagram showing a processing flow of plan matching processing;

FIG. 12 is a diagram showing an example of data stored in a work memory after the plan matching processing;

FIG. 13 is a diagram showing an example of a display screen of a search result in this embodiment;

FIG. 14 is a diagram showing a processing flow of tag information generating processing;

FIG. 15 is a diagram showing an example of a display screen of a search result in this embodiment;

FIG. 16 is a diagram showing an example of a display screen of a search result in this embodiment;

FIG. 17 is a functional block diagram of a computer.

### DETAILED DESCRIPTION OF THE PREFERRED EMBODIMENTS

Web sites called as blog (or Weblog) for recording personal experiences, diaries, etc. have broadly propagated in connection with propagation of the Internet. Furthermore, there has been recently supplied a service in which information associated with a blog (for example, the title of a blog, URL (Uniform Resource Locator), etc. and hereinafter referred to as blog registration information) is registered on a map and blog registration information can be searched from the map (hereinafter referred to as map search service).

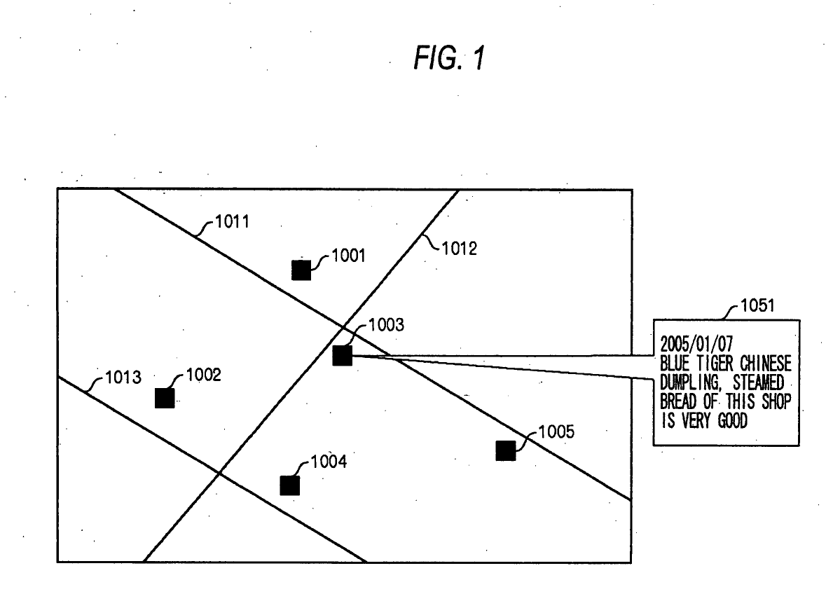

FIG. 1 shows a display example of a search result of a conventional map search service. In the example of FIG. 1, a road 1011, a road 1012 and a road 1013 are displayed, and blog registration information is registered at each position of icons 1001, 1002, 1003, 1004 and 1005. Furthermore, when the icon 1003 is clicked, a tag (for example, a display balloon) 1051 is displayed. A day on which blog registration information is registered on a map, a blog title, etc. are displayed on the tag 1051. In the example of FIG. 1, the content of the tag 1051 introduces steamed bread of a shop named as BLUE TIGER CHINESE DUMPLING located at the position of the icon 1003. As not shown, URLs of blogs may be displayed in the tag 1051, and a blog to be linked may be displayed when URL is clicked.

For example, it is considered that a user entitled to have a map search service searches blog registration information from a map and wishes to go to “BLUE TIGER CHINESE DUMPLING” located at the position of the icon 1003. However, there is a case where “BLUE TIGER CHINESE DUMPLING” has been already broken down or closed due to city development, road expansion or the like when the user actually goes to the position of the icon 1003. With only the display as shown in FIG. 1, the user cannot get a scent (information status) as to whether “BLUE TIGER CHINESE DUMPLING” has been already broken.

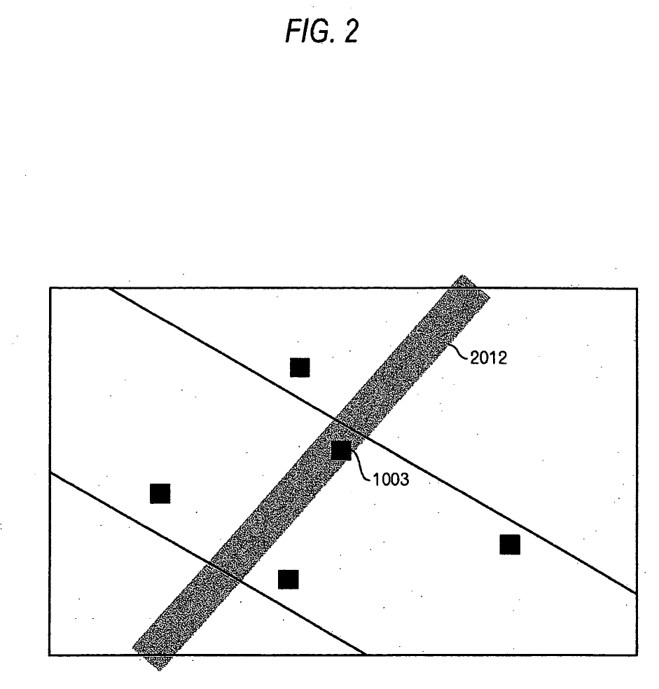

Furthermore, there is a case where the blog registration information is not renewed, but only the map is renewed. For example, FIG. 2 shows a case where the road 1012 shown in FIG. 1 is expanded and thus the map is renewed. In the example of FIG. 2, “BLUE TIGER CHINESE DUMPLING” located at the position of the icon 1003 has been broken down in connection with the expansion of the road 1012 to a road 2012, however, the blog registration information is not renewed, so that the icon 1003 is displayed with no change. In this case, a user watching a display as shown in FIG. 2 cannot judge whether the blog registration information registered at the position of the icon 1003 has been registered before the road 2012 is expanded, and thus it is impossible to judge whether “BLUE TIGER CHINESE DUMPLING” located at the position of the icon 1003 has been broken down or not. Accordingly, the user cannot perceive that “BLUE TIGER CHINESE DUMPLING” has been broken down until he/she actually goes to the position of the icon 1003.

For example, JP-A-2003-98958 discloses a technique of enabling a viewer to judge the accuracy of electronic map data. Specifically, construction dates (year, month, day), etc. of map elements are managed in a map data base, and in accordance with a reference time indicated by a map display request, map elements which exist or existed at that time point are displayed on a map. According to this publication, map elements which will be constructed in the future are managed in the map data base, and when a specific time in the future is indicated by the map display request, a map at the future specific time is displayed. Furthermore, it is also disclosed that an accuracy index is calculated for every map element, for example, on the basis of a time lapse from registration of data, and map elements are displayed on the map while distinguished from one another by using different colors in accordance with the accuracy indexes. However, the technique disclosed in this publication judges the precision of the map elements, and does not judge the precision of information registered in association with a specific position on a map (that is, the blog registration information described above).

As described above, it is impossible in the conventional technique to judge the precision of information registered in association with a specific position on a map. In the map search service, icons associated with blog registration information which may be affected by geographical variation such as city development, road expansion or the like are also displayed on the map, and thus even when a shop or the like has been already broken down, a user may refer to the information concerned without knowing that the shop or the like has been already broken down.

Accordingly, an example object of the embodiments is to provide a technique of enabling a user to judge blog registration information which is affected or may be affected by a geographical variation such as city development, road expansion or the like in a map search service, for example.

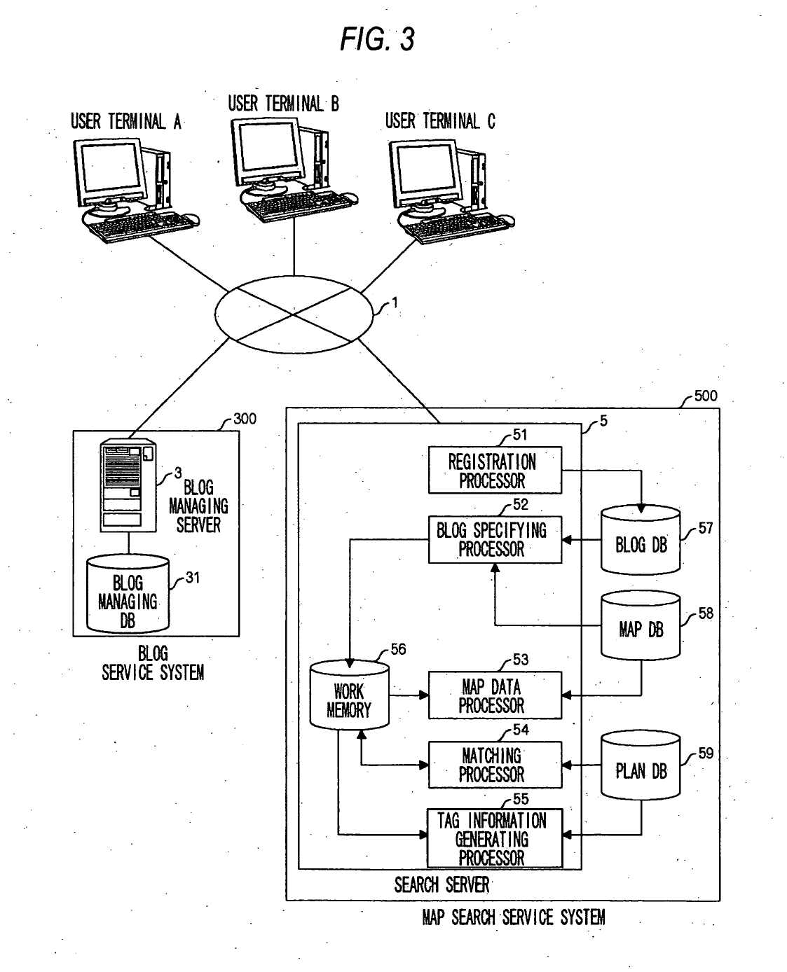

FIG. 3 is a diagram showing a system according to an embodiment. A user terminal A, a user terminal B, a user terminal C, a blog managing server 3 for managing blogs and a search server 5 for executing main processing in this embodiment are connected to a network 3 as the Internet, for example. Furthermore a Web browser is installed in each of the user terminal A, the user terminal B and the user terminal C, and accesses the blog managing server 3 or the search server 5 by the Web browser concerned. In FIG. 3, three terminals of the user terminals A, B and C are shown. However, the number of the user terminals is not limited to three, and it may be any number.

The blog managing server 3 is provided in a blog service system 300, and it can access a blog managing DB 31 contained in the blog server system 300. In the blog managing DB 31 are stored blogs and information for managing the blogs (for example, user ID, password, URL, track back number, comment number, etc.).

The search server 5 is provided in the map search service system 500, and is enabled to access a blog DB 57, a map DB 58 and a plan DB 59 contained in the map search service system 500. A blog registration information table described later is stored in the blog DB 57. Data required for generating map data (for example, data of a map itself, data concerning map elements, etc.) and a display range table described later are stored in the map DB 58. A plan table described later is stored in the plan DB 59.

Furthermore, the search server 5 has a registering processor 51 for storing program registration information received from a user terminal into the blog DB 57, a blog specifying processor for 52 for extracting blog information contained in a display range of a map to be displayed from the blog DB 57 on the basis of data stored in the blog DB 57 and the map DB 58 and storing the blog information into the work memory 56, a map data processor 53 for generating map data on the basis of data stored in the map DB 58 and the work memory 56, a matching processor 54 for executing plan matching processing described later on the basis of data stored in the plan DB 59 and the work memory 56, and a tag information generating processor 55 for executing the tag information generating processing described later on the basis of data stored in the plan DB 59 and the work memory 56. The work memory 56 is secured in a main memory or the like in the search server 5.

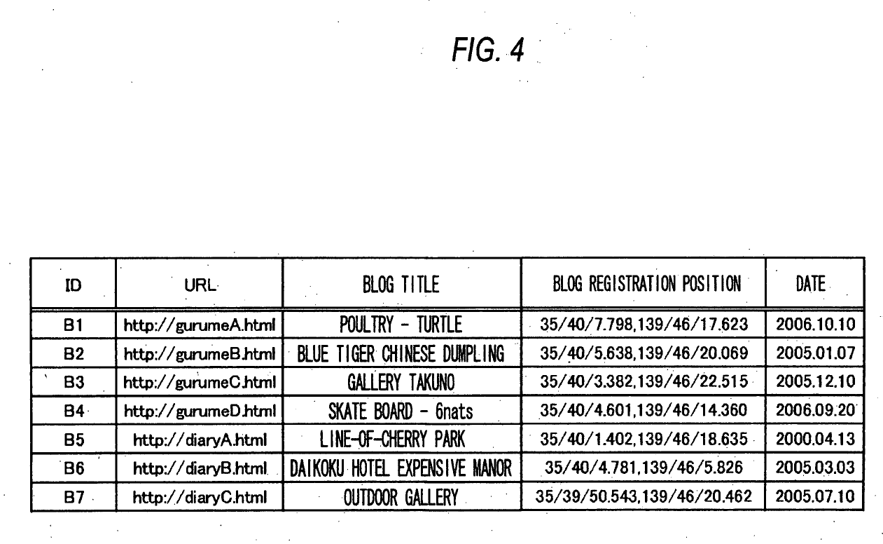

FIG. 4 shows an example of the blog registration information table stored in the blog DB 57. The example of FIG. 4 contains a column of IDs, a column of URLs, a column of blog titles, a column of blog registration positions and a column of dates. In the URL column are stored URLs of blogs in the blog service system 300 which correspond to blog registration information. Information of the latitude and longitude is stored in the blog registration position. Information other than the latitude and longitude may be stored insofar as it can specify the position on the map.

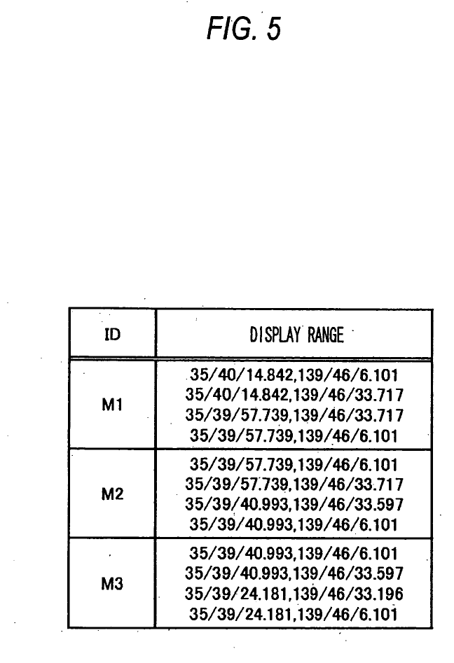

FIG. 5 shows an example of a display range table stored in the map DB 58. The example of FIG. 5 contains a column of IDs and a column of display ranges. Information of the latitude and longitude of four corners of a rectangular shape representing a display range is stored in the column of the display ranges.

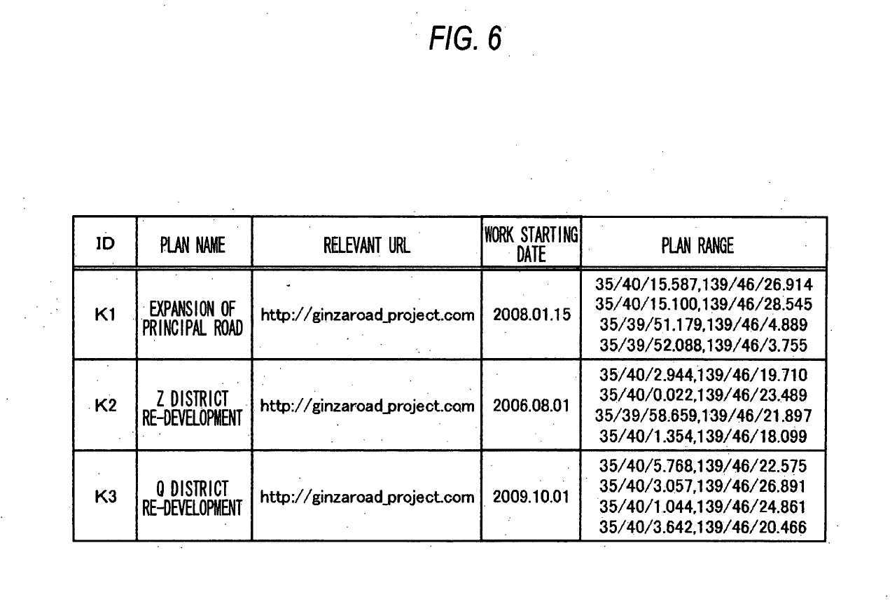

FIG. 6 shows an example of a plan table stored in the plan DB 59. The example of FIG. 6 contains a column of IDs, a column of plan names, a column of relevant URLs, a column of work starting dates and a column of plan ranges. URL of a Web site relevant to each plan is stored in the relevant URL column. A work starting data of each plan is stored in the column of work starting dates. In the plan-range column is stored the information of latitude and longitude of the four corners of a range affected by each plan (for example, in the case of a road expansion, the range of the road after the expansion). In such a case that the work starting date of the plan is not yet determined, but a service operation starting date (for example, the opening date of an express way or the like) is determined, a date which is moved up from the operation starting date by a predetermined term (for example, the date before two years from the opening date) may be stored in the work starting date column.

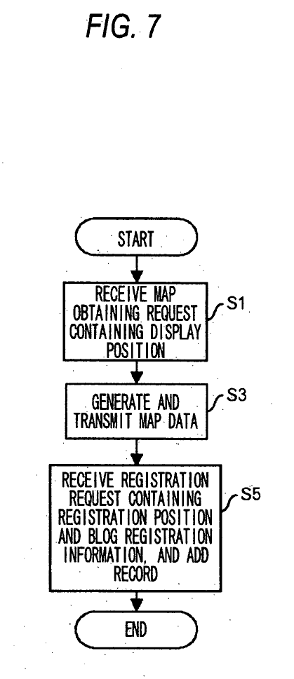

Next, the processing of the system shown in FIG. 3 will be described. First, the processing when blog registration information is registered on a map will be described with reference to FIG. 7. For example, the user A operates the user terminal A to access a registration page supplied from the search server 5. The user A is assumed to establish his/her own blog in the blog service system 300. The registering processor 51 of the search server 5 transmits registration page/data to the user terminal A in response to the access from the user terminal A. The user terminal A receives the registration page/data from the search server 5, and displays it on a display device. At this time, the map data processor 53 of the search server 5 may generate map data of a default display range (for example, a range which was finally displayed at the previous access time or the like), and contain the generated map data into the registration page/data.

For example, when the user A instructs to display a map containing a position at which the user A wishes to register blog registration information, the user terminal A accepts this instruction and transmits a map obtaining request to the search server 5. At this time, the position at which the user A wishes to register the blog registration information is contained as a display position in the map obtaining request. The map data processor 53 of the search server 5 receives the map obtaining request containing the display position (S1) from the user terminal A (S1). The map data processor 53 of the search server 5 specifies a display range on the basis of the display position contained in the received map obtaining request. The map data processor 53 of the search server 5 generates map data of the specified display range on the basis of the data stored in the map DB 58, and transmits the map data to the user terminal A S3).

The user terminal A receives the map data from the search server 5, and displays the map data on the display device. The user A checks the displayed map, and if there is no problem in the registered position, the user A inputs the blog registration information (for example, the blog title, URL of the blog, etc.) according to the registration page. The user terminal A accepts the input of the blog registration information, and transmits a registration request containing the registration position and the blog registration information to the search server 5.

The registering processor 51 of the search server 5 receives the registration request containing the registration position and the blog registration information from the user terminal A, and adds a record to the blog registration information table of the blog DB 57 (S5). In this embodiment, the day on which the registration request is received from the user terminal A is registered in the date column of the record concerned.

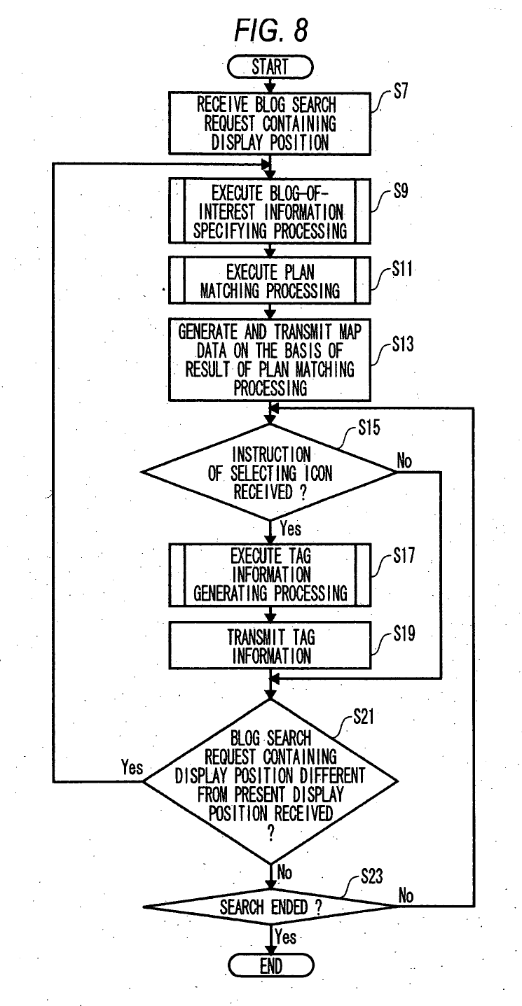

Next, the processing when the blog registration information is searched from the map will be described with reference to FIGS. 8 to 16. For example, the user B operates the user terminal B to access a search page supplied by the search server 5. The blog specifying processor 52 of the search server 5 transmits search page/data to the user terminal B in response to the access from the user terminal B. The user terminal B receives the search page/data from the search server 5 and displays it on the display device. At this time, the map data processor 53 of the search server 5 may generate map data of a default display range (for example, a range which was finally displayed at the previous access time or the like), and contain the map data into search page/data.

For example, when the user B instructs to display a map containing a position which the user wishes to search, the user terminal B accepts the instruction concerned, and transmits the blog search request to the search server 5. At this time, the position which the user B wishes to search is contained as a display position into the blog search request. The blog specifying processor 52 of the search server 5 receives the blog search request containing the display position from the user terminal B (S7), and executes the processing of specifying blog information being noted (hereinafter referred to as “noted blog information specifying processing”) (S9).

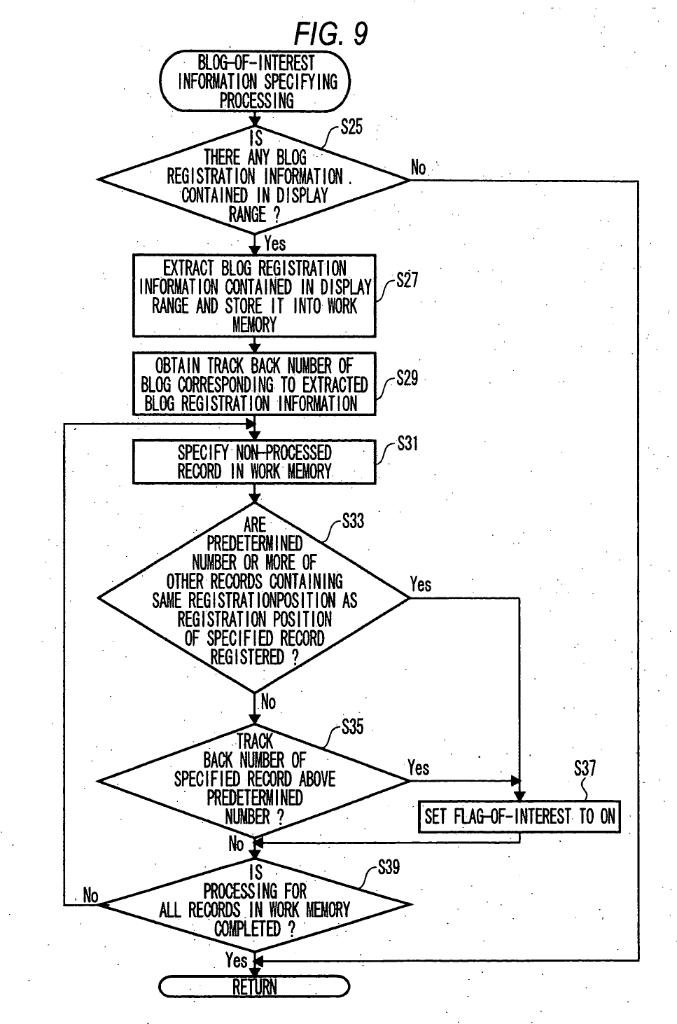

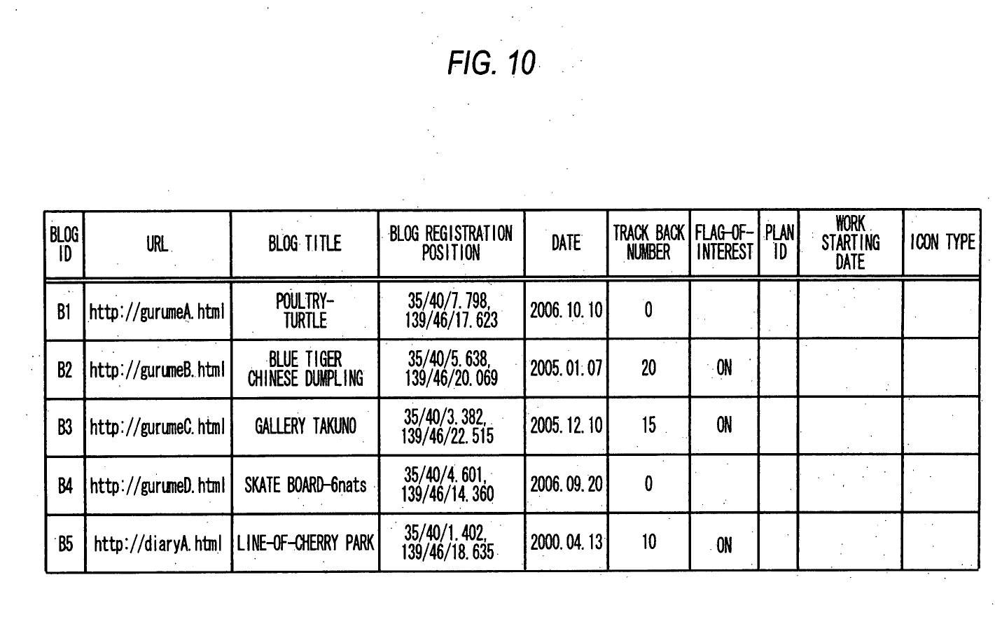

The noted blog information specifying processing will be described with reference to FIGS. 9 and 10. FIG. 9 shows the processing flow of the noted blog information specifying processing. First, the blog specifying processor 52 searches the display range table on the basis of the display position contained in the received blog search request, and specifies the display range. Then, the blog specifying processor 52 searches the blog registration information table, and judges whether there is any blog registration information contained in the display range (S25). That is, it is judged whether a record whose registration position is within the display range exists in the blog registration information table. If there is no blog registration information contained in the display range (S25: No route), the noted blog information search processing is finished, and the processing returns to the original processing. On the other hand, if there is some blog registration information contained in the display range (S25: Yes route), the blog registration information contained in the display range is extracted, and stored into the work memory 56 (S27).

FIG. 10 shows an example of data stored in the work memory 56. The example of FIG. 10 contains a column of blog IDs, a column of URLs, a column of blog titles, a column of blog registration positions, a column of dates, a column of track back numbers, a column of flags being noted (hereinafter referred to as noted flags), a column of plan IDs, a column of work starting dates and a column of icon types. The contents of the blog registration information table (FIG. 4) are stored in the blog ID, URL, the blog title, the blog registration position and date. The track back number, the noted flag, the plan ID, the work starting date and the icon type will be described later in the subsequent processing.

The blog specifying processor 52 transmits a request for obtaining the track back number of the blog corresponding to the extracted blog registration information to the blog managing server 3 in the blog service system 300 through the Internet 1. The blog managing server 3 extracts the track back number of the corresponding blog from the blog managing DB 31 in response to the request concerned, and transmits the track back number to the search server 5. The blog specifying processor 52 of the search server 5 receives the track back number from the blog managing server 3 and stores it into the work memory 56 (S29).

The blog specifying processor 52 specifies non-processed records in the work memory 56 (S31). Then, the blog specifying processor 52 judges whether a predetermined number or more of other records containing the same registration position as the specified record are registered in the work memory 56 (S33). If the predetermined number or more of the other records containing the same registration position as the specified record are not registered (S33: No route), the blog specifying processor 52 judges whether the track back number of the specified record is equal to a predetermined number or more (S35). If the track back number of the specified record is less than the predetermined number (S35: No route), the processing is shifted to the processing of S39. On the other hand, if the predetermined number or more of the other records containing the same registration position as the specified record are registered (S33: Yes route) or the track back number of the specified record is equal to the predetermined number or more (S35: Yes route), the blog specifying processor 52 sets a noted flag of the record concerned to ON (S37). Then, the blog specifying processor 52 judges whether the processing on all the records in the work memory 56 is completed or not (S39). If there is any non-processed record in the work memory 56 (S39: No route), the processing is returned to the processing of S31. On the other hand, if the processing on all the records in the work memory 56 is completed (S39: Yes route), the processing is returned to the original processing. Accordingly, blog registration information having high noting (attention) degree and high degree of interest can be specified. For example, in FIG. 10, the noted flags of records whose track back numbers are equal to 10 or more (that is, records having the blog IDs of B2, B3 and B5) are set to ON.

Returning to the description of FIG. 8, the matching processor 54 of the search server 5 executes the plan matching processing on the basis of the data stored in the plan table and the work memory 56 (S11).

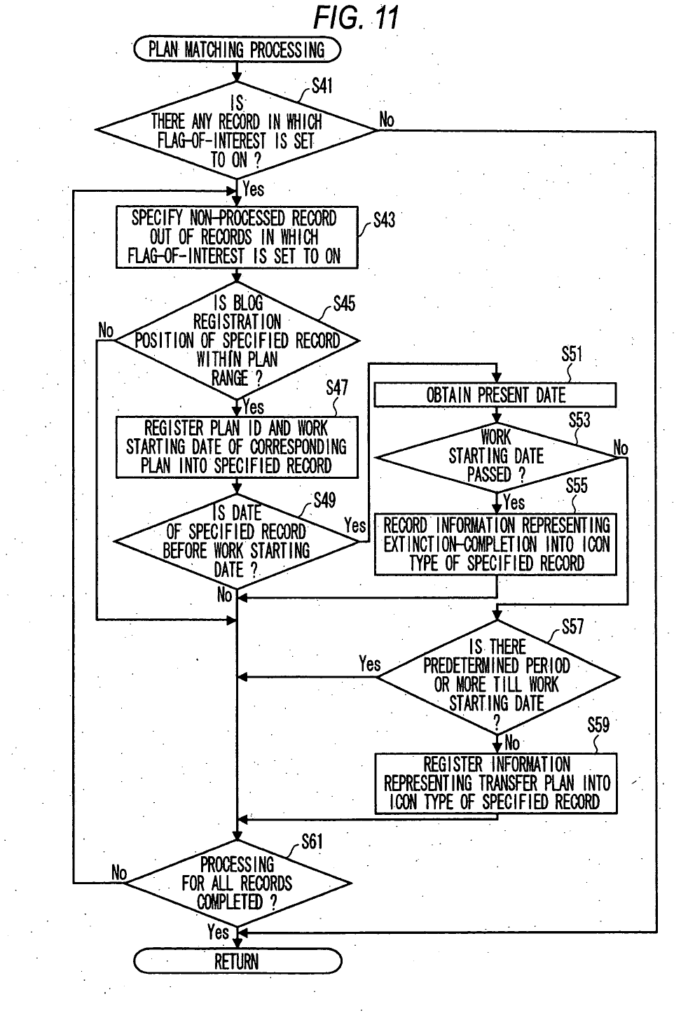

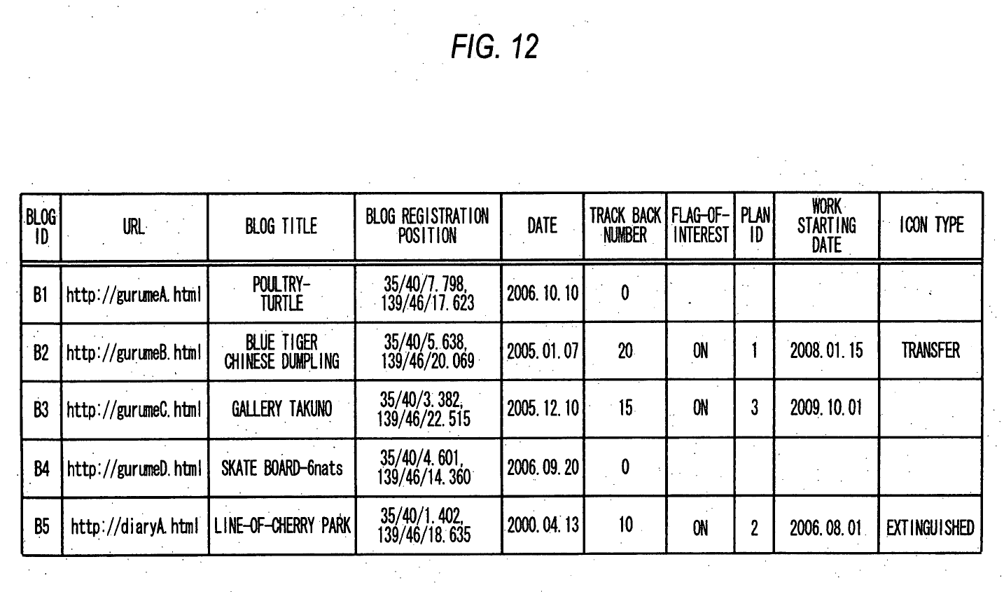

The plan matching processing will be described with reference to FIGS. 11 and 12. FIG. 11 shows the processing flow of the plan matching processing. First, the matching processor 54 judges whether a record whose noted flag is set to ON exist in the work memory 56 (S41). If any record whose noted flag is set to ON does not exist in the work memory 56 (S41: No route), the plan matching processing is finished, and the processing is returned to the original processing.

On the other hand, if some record whose noted flag is set to ON exists in the work memory 56 (S41: Yes route), the matching processor 54 specifies non-processed records out of the records whose noted flags are set to ON (S43). Then, the matching processor 54 refers to the plan table, and judges whether the blog registration position of the specified record is within the plan range of any plan (S45). If the blog registration position of the specified record is not within the plan range of any plan (S45: No route), the processing is shifted to the processing of S61. On the other hand, if the blog registration position of the specified record is within the plan range of any plan (S45: Yes route), the matching processor 54 refers to the plan record and registers the plan ID and the work starting date of the corresponding plan into the specified record (S47).

The matching processor 54 judges whether the date of the specified record is a date before the work starting date (S49). That is, it is judged whether the blog registration information was registered before the work starting date of the plan which exercises an effect. If the date of the specified record is a date subsequent to the work starting date (S49: No route), the processing is shifted to the processing of S61. On the other hand, if the date of the specified record is a date before the work starting date (S49: Yes route), the matching processor 54 obtains the present date (that is, the reception date of the blog search request) (S51). Then, the matching processor 54 judges whether the work starting date has already elapsed (S53). If the work starting date has lapse (S53: Yes route), the matching processor 54 registers information representing “extinguished” in the icon type of the specified record (S55), and then the processing is shifted to the processing of S61. On the other hand, if the work starting date has not yet come (S53: No route), the matching processor 54 calculates the term till the work starting date, and judges whether the term till the work starting date is equal to a predetermined term or more (S57). If the term till the work starting date is equal to the predetermined term or more (S57: Yes route), the processing is shifted to the processing of S61. On the other hand, if the term till the work starting date is less than the predetermined term (S57: No route), the matching processor 54 registers information representing a transfer plan into the icon type of the specified record (S59).

FIG. 12 shows an example of data stored in the work memory 56. The example of FIG. 12 is an example of data which receives a blog search request on Jan. 1, 2007 and stored into the work memory 56 after the plan matching processing when the predetermined term is set to two years. In FIG. 12, with a record whose blog ID is B2, the work starting date is equal to “2008.01.15”, and the term till the work starting date is less than the predetermined term (less than two years) although the work starting date has not yet come, so that “transfer plan” is registered in the icon type. Furthermore, with respect to a record whose blog ID is B3, the work starting date is “2009.10.01”, the work starting date has not yet come and the term till the work starting date is above the predetermined term (two years or more), so that nothing is registered in the icon type. Still furthermore, with respect to a record whose blog ID is B5, the work starting date is “2006.08.01” and the work starting date has already elapsed, so that extinguished is registered in the icon type.

The matching processor 54 judges whether the processing on all the records is completed or not (S61). If there is any non-processed record (S61: No route), the processing is returned to S43. On the other hand, if all the records have been processed (S61 Yes route), the processing is returned to the original processing.

Returning to FIG. 8, the map data processor 53 of the search server 5 generates map data on the basis of the result of the plan matching processing, and transmits it to the user terminal B (S 3). That is, the map data processor 53 of the search server 5 generates the map data on the basis of the data stored in the work memory 56 and the map DB 58.

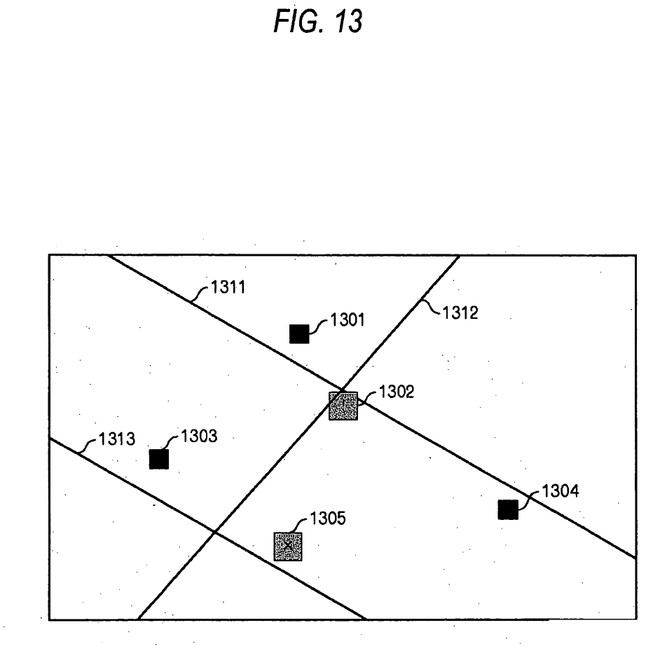

The user terminal B receives the map data from the search server 5 and displays it on the display device. FIG. 13 shows an example of the display screen (user interface) of the search result. FIG. 13 shows the example generated on the basis of the data shown in FIG. 12. In the example of FIG. 13, roads 1311, 1312 and 1313 and icons 1301, 1302, 1303, 1304 and 1305 are displayed. Furthermore, the icon 1301 corresponds to blog registration information whose blog ID is B1, the icon 1302 corresponds to blog registration information whose blog ID is B2, the icon 1303 corresponds to blog registration information whose blog ID is B3, the icon corresponds to blog registration information whose blog ID is B5. As shown in FIG. 12, the blog registration information whose blog ID is B2 and the blog registration information whose blog ID is B5 may be affected by plans. Accordingly, in FIG. 13, the icons 1302 and 1305 are displayed with emphasis (hereinafter referred to as “emphasis-display”).

Next, the search server 5 judges whether an instruction of selecting an icon from the user terminal B is received (S 5). For example, when the icon 1302 is clicked on the display screen shown in FIG. 13 by the user B, the user terminal B transmits an icon selecting instruction containing identification information of the selected icon to the search server 5. When the icon selecting instruction is received (S 5: Yes route), the tag information generating processor 55 of the search server 5 executes the tag information generating processing (S17).

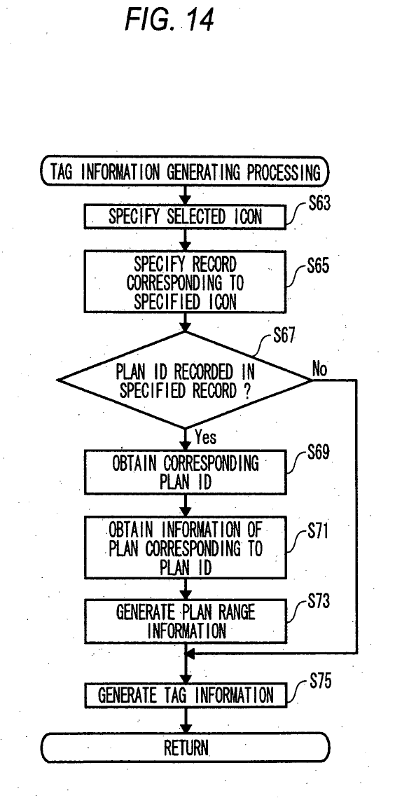

The tag information generating processor 55 will be described with reference to FIG. 14.

First, the tag information generating processor 55 specifies the selected icon (S63). Then, it refers to the work memory 56 to specify the record corresponding to the specified icon (S65). That is, since the icon 1302 is selected, the record whose blog ID is B2 is specified. The tag information generating processor 55 judges whether the plan ID is registered in the specified record (S67). If no plan ID is registered in the specified record (S67: No route), the processing is shifted to the processing of S75. On the other hand, if a plan ID is registered in the specified record (S67: Yes route), the plan ID concerned is obtained (S69). The tag information generating processor 55 obtains the information of the plan corresponding to the obtained plan ID (for example, a plan name, a plan range, etc.) from the plan table, and temporarily stores the information into the storage device or the like (S71). The tag information generating processor 55 generates plan range information for displaying the plan range on the map, and stores it into the storage device or the like (S73). The tag information generating processor 55 generates tag information for displaying a tag associated with the blog registration information on the map, and stores it into the storage device or the like (S75). When the information of the plan corresponding to the plan ID is kept, the plan name, the work starting date, etc. are contained in the tag information. Then, the processing is returned to the original processing.

Returning to FIG. 8, the tag information generating processor 55 of the search server 5 transmits the generate tag information to the user terminal B (S19). When the plan range information is generated in the tag information generating processing, the plan range information as well as the tag information is transmitted. The user terminal B receives the tag information from the search server 5, and displays it on the map displayed on the display device. When receiving both the tag information and the plan range information, the user terminal B also displays the plan range on the map.

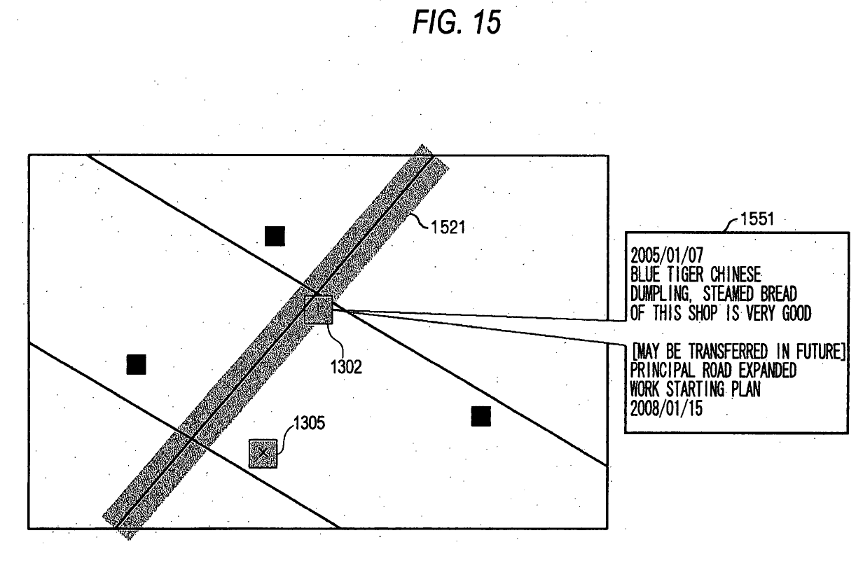

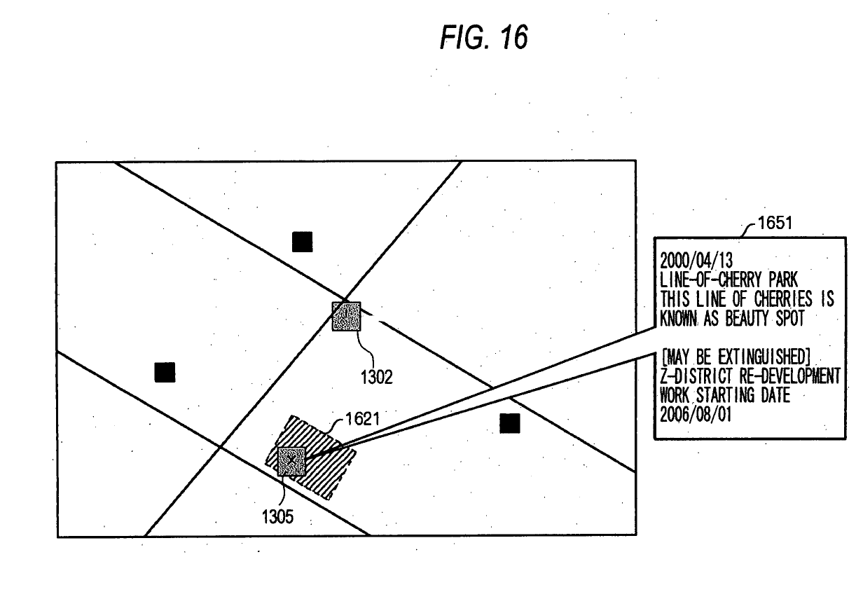

FIGS. 15 and 16 show a display screen example in which the tag and the plan range are displayed on the map. FIG. 15 shows a display screen example when the icon 1302 is selected. In FIG. 15, a tag 1551 and a plan range 1521 are displayed, and blog registration information (“2005 Jan. 7 BLUE TIGER CHINESE DUMPLING, STEAMED BREAD OF THIS SHOP IS VERY GOOD . . . . ”) and the information of the plan (“the shop may be transferred in the future”), principal road expansion, work starting plan 2008/01115”). The plan range 1521 represents a planned district of a plan exercising an effect (that is, “expansion of principal road”). Furthermore, FIG. 16 shows a display screen when the icon 1305 is selected. In FIG. 16, a tag 1651 and a plan range 1621 are displayed. In the tag 1651 are displayed blog registration information (“2000 Apr. 13 LINE-OF-CHERRY PARK This line of cherries is known as a beauty spot, . . . ”) and information of the plane (“MAY BE EXTINGUISHED!” Z-district re-development work starting date 2006 Aug. 1”). Furthermore, the plan range 1621 represents a planned district of a plan exercising an effect (that is, “Z district re-development”).

On the other hand, if no icon selecting instruction is received (S15: No route), the search server 5 judges whether a blog search request containing a display position different from the present display position (S21). If the blog search request containing the display position different from the present display position is received (S21: Yes route), the processing returns to the processing of S9. On the other hand, if the blog search request containing the display position different from the present display position is not received (S21: No route), it is judged whether an instruction of finishing the search is received or not (S23). If the instruction of finishing the search is received (S23: Yes route), the processing is finished. On the other hand, if the instruction of finishing the search is not received (S23: No route), the processing returns to the processing of S15.

As described above, according to this embodiment, for example, the icon for the blog registration information which is affected or may be affected by a geographical variation such as city development, road expansion or the like is emphasized and displayed (i.e., emphasis-displayed) in the map search service, and thus the user can identify the blog registration information which is affected or may be affected by the geographical variation. That is, the user may be free of taking an unnecessary action.

Furthermore, as described above, according to this embodiment, the plan data base may store therein the information of the work starting date of the plan. In a case where the icon selecting instruction is received from the user terminal, if it is judged that the identification information of a plan is associated with the registration information corresponding to the icon indicated by the icon selecting instruction, the map search service generates tag information containing the registration information and the information of the work starting date of the plan, or generates information for displaying the plan range of the plan on the map, and transmits it to the information to the user terminal. Accordingly, the user can know the work starting date of a plan having an effect as well as the day on which the blog registration information is registered, the title of the blog, etc. For example, when the user wishes to go to a place before the place is broken down, the user can know the day by which he/she should go to the place, for example.

Furthermore, according to this embodiment, the map search service contains at least one of the condition that the registration number of other registration information registered at the same registration position as the registration information is equal to a predetermined number or more, the condition that the track back number of the blog information which corresponds to the registration information and is managed by the blog managing server is equal to a second predetermined number or more, and the condition that the comment number of the blog information is equal to a third predetermined number or more. In this case, the blog registration information having high noting degree and high degree of interest can be narrowed down as processing targets.

Furthermore, as described above, according to this embodiment, when the registration date of the registration information contained in the plan range of the plan is before the work starting date of the plan, the map search service generates map data so that the icon corresponding to the registration information concerned is emphasis-displayed. In this case, only the icons of the blog registration information which are registered before the work starting date of the plan can be emphasis-displayed, and the blog registration information which is not affected by the plan concerned (that is, registered after the work starting date) can be displayed as normal.

Furthermore, as described above, according to this embodiment, when the registration date of the registration information contained in the plan range of the plan is before the work starting date of the plan and also the number of days from the reception day of the map obtaining request till the work starting date of the plan is less than a predetermined number of days, the map search service emphasis-displays the registration information concerned. With this setting, the judgment can be performed on the basis of an upcoming plan. For example, when the work starting date of a plan is set to a day years and years later, it is not so significant to emphasis-display the registration information. Furthermore, when the reception day of the map obtaining request is before the work starting date, the map search service can emphasis-display a map element associated with the registration information so as to indicate that the facilities corresponding to the map element described in the registration information may be transferred. When the reception day of the map obtaining request is after the work starting date of the plane, the map search service can emphasis-display the map element associated with the registration information so as to indicate that the facilities corresponding to the map element may have been already extinguished.

A program for enabling a computer to execute the registration information display method according to the embodiments can be created, and the program concerned may be stored in a storage medium such as a flexible disk, CD-ROM, a magneto-optical disk, a semiconductor memory, a hard disk or the like, or a storage device. Furthermore, the program concerned may be distributed in the form of digital signals through a network. With respect to data under processing, they may be temporarily held in a storage device such as a memory or the like of the computer.

The embodiments are not limited to the above embodiment, and various modifications may be made without departing from the subject matter of the embodiments. For example, the functional block diagram described above does not necessarily correspond to the actual program module construction. The search server 5 may be implemented not by one computer, but by plural computers. The described embodiment features may be provided in any combinations.

Furthermore, the construction of each table described above is an example, and each table does not necessarily have the construction described above. Furthermore, in the processing flow, the processing order may be rearranged insofar as the processing result is not varied. Furthermore, the processing may be executed in parallel.

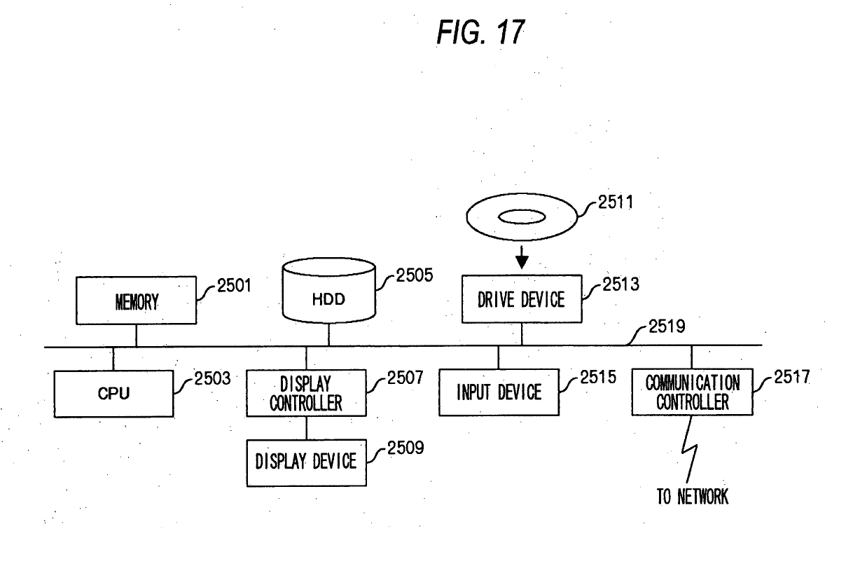

The embodiments may be implemented in computing hardware and/or software. For example, each of the user terminal A, the user terminal B, the user terminal C, the blog managing server 3 and the search server 5 is a computer device as shown in FIG. 17, and it comprises a memory 2501 (storage device), CPU 2503 (processing unit), a hard disk drive (HDD) 2505, a display controller 2507 connected to a display device 2509, a drive device 2513 for a removable disk 2511, an input device 2515 and a communication controller 2517 connected to a network, which are connected to one another through a bus 2519. An operating system (OS) and an application program for executing the processing in this embodiment are stored in HDD 2505, it is read out from HDD 2505 to the memory 2501 when the program is executed by CPU 2503. CPU 2503 controls the display controller 2507, the communication controller 2517 and the drive device 2513 to execute necessary operations as occasion demands. Furthermore, the data under processing are stored in the memory 2501, and also stored in HDD 2505 as occasion demands.

In the embodiments, the application program for implementing the processing described above is stored in the removable disk 2511 to be distributed, and installed from the drive device 2513 to HDD 2505. The application program may be installed into HDD 2505 through a network such as the Internet and the communication controller 2517. In such a computer device, the hardware such as CPU 2503, the memory 2501, etc. described above, OS and necessary application programs are organically cooperated with one another to implement the various kinds of functions as described above.

What is claimed is:

1. A registration information display processing method executed by a computer accessing a registration information data base for storing registration information which is registered in association with a specific position on a map as registration position of the registration information, and a plan data base for storing identification information of a plan having an effect on a map element and a plan range of the plan concerned, the method comprising:
extracting registration information, whose registration position is contained in an indicated display range, from the registration information stored in the registration information data base, when a map obtaining request containing the indicated display range is received from a user terminal;
in-plan-range judging by judging whether the registration position of the extracted registration information is within the plan range of the plan stored in the plan data base;
plan associating by storing the identification of the plan in association with the extracted registration information, when judged the registration position of the extracted registration information is within the plan range of the plan stored in the plan data base; and
generating map data emphasis-displaying an icon corresponding to the extracted registration information associated with the identification information of the plan; and
transmitting the map data to a user terminal.

2. The registration information display processing method according to claim 1, wherein information of a work starting date of the plan is further contained in the plan data base, and the method further comprises when an icon selecting instruction from the user terminal is received, judging whether the registration information corresponding to the icon indicated by the icon selecting instruction is associated with the identification information of the plan, and generating tag information containing the registration information and the information of the work starting date of the plan and transmitting the tag information to the user terminal, when according to the judging the registration information corresponding to the icon indicated by the icon selecting instruction is associated with the identification information of the plan.

3. The registration information display processing method according to claim 2, wherein the tag information generating generates information for displaying the plan range of the plan on a map and transmitting the generated information to the user terminal.

4. The registration information display processing method according to claim 1, further comprising specifying registration information satisfying a predetermined condition, and subsequent to the in-plan-range judging on the registration information, determining whether the registration information satisfies the predetermined condition.

5. The registration information display processing method according to claim 4, wherein the predetermined condition contains a condition that the registration number of other registration information registered at same position as the registration position of the registration information is equal to a predetermined number or more, a condition that a track back number of blog information which corresponds to the registration information and is managed by a blog managing server is equal to a second predetermined number or more, or a condition that a number of comments of the blog information is equal to a third predetermined number or more, or any combinations thereof.

6. The registration information display processing method according to claim 1, wherein the registration information data base further stores information of a registration date of the registration information, the plan data base further stores information of a work starting date of the plan, the plan associating comprises comparing the work starting date of the plan with the registration date of the registration information contained in the plan range of the plan with respect to the registration information contained in the plan range of the plan, and an emphasis-display information registering by storing information representing necessity of emphasis-display in association with the registration information, and the map data generating comprises generating map data emphasis-displaying the icon corresponding to the registration information associated with the information representing the necessity of the emphasis-display.

7. The registration information display processing method according to claim 6, wherein the emphasis-display information registering comprises comparing a reception date of the map obtaining request with the work starting date of the plan when the registration date of the registration information contained in the plan range of the plan is before the work starting date of the plan, and storing information representing necessity of the emphasis-display in association with the registration information, when the reception date of the map obtaining request is before the work starting date of the plan and a difference in number of days between the reception date of the map obtaining request and the work starting date is less than a predetermined number of days.

8. The registration information display processing method according to claim 7, wherein the emphasis-display information registering further comprises storing as information representing the necessity of the emphasis-display, information representing that a map element associated with the registration information may be transferred when the reception date of the map obtaining request is before the work starting date of the plan.

9. The registration information display processing according to claim 7, wherein the emphasis-display information registering further comprising storing as information representing the necessity of the emphasis-display, information representing that a map element associated with the registration information may have been already extinguished, when the reception date of the map obtaining request is after the work starting date of the plan.

10. A recording medium having a registration information display processing program stored therein, the program making a computer execute:
extracting registration information, whose registration position is contained in an indicated display range, from registration information stored in a registration information data base storing the registration information in association with a specific position on a map as registration position of the registration information, when a map obtaining request containing an indication of the display range is received from a user terminal;
in-plan-range judging by referring to a plan data base storing identification information of a plan affecting map elements and a plan range of the plan, and judging whether the registration position of the registration information stored in the storage device is contained in the plan range of the plan stored in the plan data base;
plan associating by storing the identification information of the plan stored in the plan data base in association with the extracted registration information, when judged the registration position of the extracted registration information is contained in the plan range of the plan; and
generating map data emphasis-displaying an icon corresponding to the extracted registration information associated with the identification information of the plan; and
transmitting the map data to the user terminal.

11. A registration information display processing device in communication with a user terminal, comprising:
a registration information data base storing registration information which is registered in association with a specific position on a map as registration position of the registration information;
a plan data base storing identification information of a plan having an effect on a map element and a plan range of the plan; and
a controller
extracting registration information, whose registration position is contained in an indicated display range, from the registration information stored in the registration information data base, when a map obtaining request containing the indicated display range is received from the user terminal,
in-plan-range judging by judging whether the registration position of the extracted registration information is within the plan range of the plan stored in the plan data base;
plan associating by storing the identification of the plan in association with the extracted registration information, when judged the registration position of the extracted registration information is within the plan range of the plan stored in the plan data base; and
generating map data emphasis-displaying an icon corresponding to the extracted registration information associated with the identification information of the plan, and
transmitting the map data to the user terminal.
